(19) United States
(12) Patent Application Publication
(10) Pub. No.: US 2013/0338222 A1
(43) Pub. Date: Dec. 19, 2013

(54) METHODS FOR CONTROLLING VARRO MITES

(71) Applicant: Andre Fougeroux, Guyancourt (FR)

(72) Inventor: Andre Fougeroux, Guyancourt (FR)

(73) Assignee: SYNGENTA CROP PROTECTION LLC, Greensboro, NC (US)

(21) Appl. No.: 13/878,530

(22) PCT Filed: Sep. 30, 2011
(86) PCT No.: PCT/EP2011/067079

§ 371 Date: Sep. 3, 2013

(30) Foreign Application Priority Data
Oct. 1, 2010 (EP) 10306075.2

(51) Int. Cl. A01N 43/12

(52) U.S. Cl. CPC A01N 43/12
USPC 514/462

(57) ABSTRACT

The present invention relates to methods and compositions comprising spirodiclofen and/or spiromesifen for the control of bee mites and for the reduction of bee mite infestations, such as the control and reduction of infestations of parasitic bee mites, such as Varroa destructor in bee, preferably honey bee, colonies, and to the treatment of varroatosis in bees.

The present invention relates to methods and compositions comprising spirodiclofen and/or spiromesifen for the control of bee mites and for the reduction of bee mite infestations, such as the control and reduction of infestations of parasitic bee mites, such as Varroa destructor in bee colonies, and to the treatment of varroatosis in bees.

Bee-keeping is an important component of agricultural industry, directly providing honey for the food markets as well as playing a key role in the pollination of other food crops. It has been estimated that honey bee pollination accounts for about one third of US food crops. It has been assessed that the pollination value worldwide is 153bios [symbol] (Gallai and al. 2008). In 2006 a sharp decline was observed in US honey bee colonies, known as Colony Collapse Disorder (CCD), due to as yet unknown causes, with initial theories focused on pathogens, parasites, environmental stresses and bee management stresses as potential causes. Later research has found a strong correlation between incidences of Israeli acute paralysis virus (IAPV) and CCD (Johnson, Renee; “Recent Honey Bee Colony Declines”; Congressional Research Service Report for Congress; 28 May 2008; Order Code RL33938).

The main species of parasites responsible for problems in honey bees are Varroa mites (Varroa destructor) and tracheal mites (Acarapis woods). The former are the most serious and may bring about the destruction of whole colonies. Additionally, the IAPV can be transmitted by the Varroa mite which could therefore be a contributory factor in CCD. Varroa is also known to transmit other viruses, in particular deformed wing virus (DVW). Current treatment methods for controlling Varroa mites in honey bees include mainly the use of fluvalinate, amitraz, formic acid, coumaphos, thymol and sucrose octanoate. Limitations of current methods include lack of efficacy, generation of resistance, handling difficulties and also contamination of beeswax destined for human use. The disease caused by the Varroa mite is known as varroatosis.

There exists a need therefore for alternative methods of control of bee mites, particularly Varroa destructor, preferably having improved efficacy, improved selectivity, lower tendency to generate resistance and generally being less toxic, in particular to bees and beekeepers. Further, methods are needed against Varroa that have built-up resistance with current solutions, such as against pyrethroid-resistant (such as fluvalinate & tau-fluvalinate) Varroa destructor.

Spirodiclofen (3-(2,4-dichlorophenyl)-2-oxo-1-oxaspiro[4.5]dec-3-en-4-yl 2,2-dimethylbutyrate) and spiromesifen (3-mesityl-2-oxo-1-oxaspiro[4.4]non-3-en-4-yl 3,3-dimethylbutyrate) are members of the Ketoenoles (tetronic acids) family of pesticides. It has surprisingly been found that each spirodiclofen and spiromesifen has activity against the Varroa mite and is therefore useful as a miticide in the protection of bee colonies.

Accordingly, the present invention provides for the use of spirodiclofen and/or spiromesifen, or an agrochemically acceptable salt of each thereof for the control of, or protection against, bee mites. In a preferred embodiment, the present invention provides for the use of a composition comprising spirodiclofen and/or spiromesifen, or an agrochemically acceptable salt of each thereof, and an agrochemically acceptable diluent or carrier, for the control of, or protection against, bee mites. References to spirodiclofen and spiromesifen herein shall be deemed to include both spirodiclofen and agrochemically acceptable salts thereof, and spiromesifen and agrochemically acceptable salts thereof respectively.

The spirodiclofen and/or spiromesifen, or an agrochemically acceptable salt of each thereof and compositions thereof of the present invention may be useful against bee mites, including tracheal mites and Varroa mites.

In another aspect, the present invention provides for the use of spirodiclofen and/or spiromesifen for reducing infestations of bee mites. In a preferred embodiment, the present invention provides for the use of a composition comprising spirodiclofen and/or spiromesifen and an agrochemically acceptable diluent or carrier for reducing infestations of bee mites.

In another aspect, the present invention provides for the use of spirodiclofen and/or spiromesifen for the protection of bees against attack by mites. In a preferred embodiment, the present invention provides for a composition comprising spirodiclofen and/or spiromesifen, and an agrochemically acceptable diluent or carrier for the protection of bees against attack by mites.

The present invention also encompasses methods for controlling or protecting against bee mites which comprises bringing the mites in their various stages of development into contact with spirodiclofen and/or spiromesifen or compositions comprising spirodiclofen and/or spiromesifen, and optionally other active agents.

The spirodiclofen and/or spiromesifen, compositions thereof uses thereof and methods of the present invention are most suitable for use against mites of the genus Varroa, such as the species Varroa destructor Preferably, the species to be controlled or protected against is Varroa destructor.

In another preferred aspect, the present invention provides for the use of spirodiclofen and/or spiromesifen for the treatment of varroatosis. In a preferred embodiment, the present invention provides for the use of a composition comprising spirodiclofen and/or spiromesifen and an agrochemically acceptable diluent or carrier for the treatment of varroatosis.

In another preferred aspect, the present invention provides a method for the treatment of varroatosis which comprises bringing the mites in their various stages of development into contact with spirodiclofen and/or spiromesifen. In a preferred embodiment, the present invention provides a method for the treatment of varroatosis which comprises bringing the mites in their various stages of development into contact with a composition comprising spirodiclofen and/or spiromesifen and an agrochemically acceptable diluent or carrier.

The spirodiclofen and/or spiromesifen and compositions thereof of the present invention may be used to treat any bee species affected by parasites such as bumblebees (genus Bombus) mason bee (genus Osmia), alfalfa leafcutter bee (genus Megachile) and honeybees (genus Apis), with a particular need for the treatment and protection of honey bees.

The spirodiclofen and/or spiromesifen and compositions thereof of the present invention may be used in any suitable manner to treat the bees such as directly spraying the bees or treatment of or the area around their hives. The spirodiclofen and/or spiromesifen and compositions thereof of the present invention are preferably used for the treatment of honey bees or in or around their hives.

Accordingly, in a preferred aspect, the present invention provides for the use of spirodiclofen and/or spiromesifen for reducing infestations of bee mites in a bee, preferably honey bee, colony. In a preferred embodiment, the present invention provides for the use of a composition comprising spirodiclofen and/or spiromesifen and an agrochemically acceptable diluent or carrier for reducing infestations of bee mites in a bee, preferably honey bee, colony.

In another preferred aspect, the present invention provides for the use of spirodiclofen and/or spiromesifen for the control of or protection against bee mites in a bee, preferably honey bee, colony. In a preferred embodiment, the present invention provides for the use of a com position comprising spirodiclofen and/or spiromesifen and an agrochemically acceptable diluent or carrier for the control of or protection against bee mites in a bee, preferably honey bee, colony.

In another preferred aspect, the present invention provides for the use of spirodiclofen and/or spiromesifen for the treatment of varroatosis in a bee, preferably honey bee, colony. In a preferred embodiment, the present invention provides for the use of a composition comprising spirodiclofen and/or spiromesifen and an agrochemically acceptable diluent or carrier for the treatment of varroatosis in a bee, preferably honey bee, colony.

In another preferred aspect, the present invention provides a method for the treatment of varroatosis in a bee, preferably honey bee, colony which comprises bringing the mites in their various stages of development into contact with spirodiclofen and/or spiromesifen. In a preferred embodiment, the present invention provides a method for the treatment of varroatosis in a bee, preferably honey bee, colony which comprises bringing the mites in their various stages of development into contact with a composition comprising spirodiclofen and/or spiromesifen and an agrochemically acceptable diluent or carrier.

The spirodiclofen and/or spiromesifen of the present invention may be used in unmodified form or, preferably, together with the adjuvants conventionally employed in the art of formulation, and are therefore formulated in known manner e.g. into emulsifiable concentrates, directly sprayable or dilutable solutions, dilute emulsions, wettable powders, soluble powders, dusts, granulates, and also encapsulations in e.g. polymer substances. As with the compositions, the methods of application, such as spraying, atomising, dusting, scattering or pouring, are chosen in accordance with the intended objectives and the prevailing circumstances.

Application of the spirodiclofen and/or spiromesifen and compositions of the invention may be performed one or more times, such as two to three times at intervals of 4 to 20 days, preferably at intervals of 1 to 2 weeks, during summertime after the last bee, preferably honey bee, production and before the cells are capped. The spirodiclofen and/or spiromesifen or compositions thereof may be applied to the top frame of the hive or applied to strips which are then inserted into the hive.

In each and every embodiment of the present invention, only one of spirodiclofen and spiromesifen is preferably present. In each and every embodiment of the present invention, spirodiclofen is used as the active ingredient. In each and every embodiment of the present invention, spiromesifen is used as the active ingredient.

The rates of application of spirodiclofen per hive would depend on a number of factors, such as the population of the hive, application methods and LDO of spirodiclofen and/or spiromesifen against bees. In an embodiment, an effective rate of
spirodiclofen per hive is from 6 to 18, preferably 10 to 14, grams of Al; and
spiromesifen per hive 3.5 to 12, preferably 6 to 10, grams of Al.

In an additional aspect, the present invention provides a device or composition comprising spirodiclofen and/or spiromesifen which releases the active agent into a bee hive to be treated in a controlled manner so as to maintain an effective concentration of the active agent within the hive that is sufficient to kill mites that infest, or may infest, the hive. Preferably the device or composition maintains an effective concentration of active agent for up to 20 days, for example from 1 to 10 days, or 3 to 7 days.

The device or composition preferably maintains the concentration of active agent(s) in the hive below a level that may have a detrimental effect on the bees.

Preferred is a device or composition which maintains an effective concentration of active agent in the hive for up to 20 days, below a level that may have a detrimental effect on the bees.

The formulations, i.e. the compositions, preparations or mixtures containing the spirodiclofen and/or spiromesifen and, where appropriate, a solid or liquid adjuvant, are prepared in known manner, e.g. by homogeneously mixing and/or grinding the active ingredients with extenders, e.g. solvents, solid carriers and, where appropriate, surface-active compounds (surfactants).

In an embodiment, the formulation comprising spirodiclofen is formulated as a soluble concentrate, granule (such as WP or WG) or a powder.

Further, the present invention also make available the compositions, comprising (I) spirodiclofen and/or spiromesifen (II) one or more other agents suitable for use in treating bee mites, such as fluvalinate, tau-fluvalinmate, amitraz, formic acid, coumaphos, thymol and sucrose octanoate, and (III) an agrochemically acceptable diluent or carrier.

The present invention accordingly provides a method for the treatment of varroatosis in a bee, preferably honey bee, colony which comprises bringing the mites in their various stages of development into contact with a composition comprising (I) spirodiclofen and/or spiromesifen, (II) one or more other agents suitable for use in treating bee mites, such as fluvalinate, tau-fluvalinmate, amitraz, formic acid, coumaphos, thymol and sucrose octanoate, and (III) an agrochemically acceptable diluent or carrier.

Examples of devices include a strip of material, such as plastic, to which the active substance is applied.

Suitable solvents are: aromatic hydrocarbons, preferably the fractions containing 8 to 12 carbon atoms, e.g. xylene mixtures or substituted naphthalenes, phthalates, such as dibutyl phthalate or dioctyl phthalate, aliphatic hydrocarbons, such as cyclohexane or paraffins, alcohols and glycols and their ethers and esters, such as ethanol, ethylene glycol, ethylene glycol monomethyl or monoethyl ether, ketones, such as cyclohexanone, strongly polar solvents, such as N-methyl-2-pyrrolidone, dimethyl sulfoxide or dimethylformamide, as well as vegetable oils or epoxidised vegetable oils, such as epoxidised coconut oil or soybean oil; or water.

The solid carriers used e.g. for dusts and dispersible powders are normally natural mineral fillers, such as calcite, talcum, kaolin, montmorillonite or attapulgite. In order to improve the physical properties it is also possible to add highly dispersed silicic acids or highly dispersed absorbent polymers. Suitable granulated adsorptive carriers are porous types, for example pumice, broken brick, sepiolite or bentonite; and suitable nonsorbent carriers are, for example, calcite or sand. In addition, a great number of granulated materials of inorganic or organic nature can be used, e.g. especially dolomite or pulverised plant residues.

Suitable surface-active compounds are non-ionic, cationic and/or anionic surfactants having good emulsifying, dispersing and wetting properties. The term “surfactants” will also be understood as comprising mixtures of surfactants. Both so-called water-soluble soaps and also water-soluble synthetic surface-active compounds are suitable anionic surfactants.

Suitable soaps are the alkali metal salts, alkaline earth metal salts or unsubstituted or substituted ammonium salts of higher fatty acids (C₁₀-C₂₂), e.g. the sodium or potassium salts of oleic or stearic acid, or of natural fatty acid mixtures which can be obtained e.g. from coconut oil or tall oil. Other suitable surfactants that may be mentioned are fatty acid methyltaurin salts and modified and unmodified phospholipids.

More frequently, however, so-called synthetic surfactants are used, especially fatty sulfonates, fatty sulfates, sulfonated benzimidazole derivatives or alkylarylsulfonates. The fatty sulfonates or sulfates are usually in the form of alkali metal salts, alkaline earth metal salts or unsubstituted or substituted ammonium salts and generally contain a C₈-C₂₂ alkyl radical which also includes the alkyl moiety of acyl radicals, e.g. the sodium or calcium salt of lignosulfonic acid, of dodecylsulfate or of a mixture of fatty alcohol sulfates obtained from natural fatty acids. These compounds also comprise the salts of sulfated and sulfonated fatty alcohol/ethylene oxide adducts. The sulfonated benzimidazole derivatives preferably contain 2 sulfonic acid groups and one fatty acid radical containing about 8 to 22 carbon atoms. Examples of alkylarylsulfonates are the sodium, calcium or triethanolamine salts of dodecylbenzenesulfonic acid, dibutylnaphthalenesulfonic acid, or of a condensate of naphthalenesulfonic acid and formaldehyde. Also suitable are corresponding phosphates, e.g. salts of the phosphoric acid ester of an adduct of p-nonylphenol with 4 to 14 moles of ethylene oxide.

Non-ionic surfactants are preferably polyglycol ether derivatives of aliphatic or cycloaliphatic alcohols, saturated or unsaturated fatty acids and alkylphenols, said derivatives containing 3 to 30 glycol ether groups and 8 to 20 carbon atoms in the (aliphatic) hydrocarbon moiety and 6 to 18 carbon atoms in the alkyl moiety of the alkylphenols. Further suitable non-ionic surfactants are the water-soluble adducts of polyethylene oxide with polypropylene glycol, ethylenediaminopolypropylene glycol and alkylpolypropylene glycol containing 1 to 10 carbon atoms in the alkyl chain, which adducts contain 20 to 250 ethylene glycol ether groups and 10 to 100 propylene glycol ether groups. These compounds usually contain 1 to 5 ethylene glycol units per propylene glycol unit.

Representative examples of non-ionic surfactants are nonylphenolpolyethoxyethanols, castor oil polyglycol ethers, polypropylene/polyethylene oxide adducts, tributylphenoxypolyethoxyethanol, polyethylene glycol and octylphenoxypolyethoxyethanol. Fatty acid esters of polyoxyethylene sorbitan, e.g. polyoxyethylene sorbitan trioleate, are also suitable non-ionic surfactants.

Cationic surfactants are preferably quaternary ammonium salts which contain, as N-substituent, at least one C₈-C₂₂ alkyl radical and, as further substituents, unsubstituted or halogenated lower alkyl, benzyl or hydroxy-lower alkyl radicals. The salts are preferably in the form of halides, methyl sulfates or ethyl sulfates, e.g. stearyl trimethylammonium chloride or benzyl di(2-chloroethyl)ethylammonium bromide.

The surfactants customarily employed in the art of formulation are described, inter alia, in the following publications: “Mc Cutcheon's Detergents and Emulsifiers Annual” MC Publishing Corp., Ridgewood, N.J., 1979; Dr. Helmut Stache “Tensid Taschenbuch”, Carl Hanser Verlag, Munich/Vienna 1981.

The pesticidal compositions according to the invention usually contain 0.1 to 99%, preferably 0.1 to 95%, of active agent or combinations thereof with other insecticides or acaricides, 1 to 99.9% of a solid or liquid adjuvant, and 0 to 25%, preferably 0.1 to 20%, of a surfactant. Whereas commercial products will preferably be formulated as concentrates, the end user will normally employ dilute formulations containing substantially lower concentrations of active ingredient.

The compositions according to the invention may also contain further additives such as stabilisers, antifoams, viscosity regulators, binders and tackifiers as well as fertilisers or other active ingredients for obtaining special effects.

### FORMULATION EXAMPLES

### Throughout, Percentages Are By Weight

Example F1: Solutions

| | a) | b) | c) | d) |
|---|---|---|---|---|
| active ingredient | 80% | 10% | 5% | 95% |
| ethylene glycol monomethyl ether | 20% | — | — | — |
| polyethylene glycol (mol. wt 400) | — | 70% | — | — |
| N-methyl-2-pyrrolidone | — | 20% | — | — |
| epoxidised coconut oil | — | — | 1% | 5% |
| petroleum fraction (boiling range 160-190. | — | — | 94% | — |
| degree.) | | | | |

These solutions are suitable for application in the form of micro-drops.

Example F2: Granules

| | a) | b) | c) | d) |
|---|---|---|---|---|
| active ingredient | 5% | 10% | 8% | 21% |
| Kaolin | 94% | — | 79% | 54% |
| Highly dispersed silicic acid | 1% | — | 13% | 7% |
| Attapulgite | — | 90% | — | 18% |

The active ingredient is dissolved in dichloromethane, the solution is sprayed onto the carrier, and the solvent is subsequently evaporated off in vacuo.

Example F3: Dusts

| | a) | b) |
|---|---|---|
| active ingredient | 2% | 5% |
| Highly dispersed silicic acid | 1% | 5% |
| Talcum | 97% | — |
| Kaolin | — | 90% |

Ready-for-use dusts are obtained by intimately mixing the carriers with the active ingredient.

Example F4: Wettable powders

| | |
|---|---|
| active ingredient | 25% |
| Sodium sulphate | 5% |
| castor oil polyethylene glycol ether (36-37 mol of | 10% |
| ethylene oxide) | |
| silicone oil | 1% |
| Agridex | 2% |
| highly dispersed silicic acid | 10% |
| kaolin powder | 37% |
| sulfite spent lye powder | 5% |
| Ultravon W-300% (disodium salt of 1-benzyl-2 | 5% |
| heptadecylbenzimidazole-X,X′-disulfonic acid) | |

The active ingredient is mixed with the other formulation components and the mixture is ground in a suitable mill, affording wettable powders which can be diluted with water to give suspensions of the desired concentration.

Example F5: Dusts

| | a) | b) |
|---|---|---|
| active ingredient | 5% | 8% |
| Talcum | 95% | — |
| Kaolin | — | 92% |

Ready-for-use dusts are obtained by mixing the active ingredient with the carrier and grinding the mixture in a suitable mill.

Example F6: Extruder granules

| | |
|---|---|
| active ingredient | 10% |
| Sodium lignosulfonate | 2% |
| Carboxymethylcellulose | 1% |
| Kaolin | 87% |

The active ingredient is mixed and ground with the other formulation components, and the mixture is subsequently moistened with water. The moist mixture is extruded and granulated and then the granules are dried in a stream of air.

Example F7: Coated granules

| | |
|---|---|
| active ingredient | 3% |
| Polyethylene glycol (mol. wt. 200) | 3% |
| Kaolin | 94% |

The finely ground active ingredient is uniformly applied, in a mixer, to the kaolin moistened with polyethylene glycol. Non-dusty coated granules are obtained in this manner.

Example F8: Suspension concentrate

| | |
|---|---|
| active ingredient | 40% |
| Ethylene glycol | 10% |
| Nonylphenol polyethylene glycol | 6% |
| Ether (15 mol of ethylene oxide) | |
| Sodium lignosulfonate | 10% |
| Carboxymethylcellulose | 1% |
| Aqueous formaldehyde solution (37%) | 0.2% |
| Aqueous silicone oil emulsion (75%) | 0.8% |
| Water | 32% |

The finely ground active ingredient is intimately mixed with the other formulation components giving a suspension concentrate from which suspensions of any desired concentration can be obtained by dilution with water.

Example F9: Emulsifiable concentrates

| | a) | b) | c) |
|---|---|---|---|
| active ingredient | 25% | 40% | 50% |
| Calcium dodecylbenzenesulfonate | 5% | 8% | 6% |
| Castor oil polyethylene glycol ether (36 mol of | 5% | — | — |
| ethylene oxide) | | | |
| Tristyrylphenol polyethylene glycol ether (30 | — | 12% | 4% |
| mol of ethylene oxide | | | |
| Cyclohexanone | — | 15% | 20% |
| Xylene mixture | 65% | 25% | 20% |

Emulsions of any desired concentration can be produced from such concentrates by dilution with water.

Example F10: Wettable powders

| | a) | b) | c) |
|---|---|---|---|
| active ingredient | 25% | 50% | 75% |
| Sodium lignosulfonate | 5% | 5% | — |
| Sodium laurylsulfate | 3% | — | 5% |
| Sodium diisobutylnapthalene-sulfonate | — | 6% | 10% |
| Octylphenol polyethylene glycol ether (7-8 mol of | — | 2% | — |
| ethylene oxide) | | | |
| Highly dispersed silicic acid | 5% | 10% | 10% |
| Kaolin | 62% | 27% | — |

The active ingredient is mixed with the other formulation components and the mixture is ground in a suitable mill, affording wettable powders which can be diluted with water to give suspensions of the desired concentration.

Example F11: Emulsifiable concentrate

| | |
|---|---|
| active ingredient | 10% |
| Octylphenol polyethylene glycol ether (4-5 mol of ethylene oxide) | 3% |
| Calcium dodecylbenzenesulfonate | 3% |
| Castor oil polyglycol ether (36 mol of ethylene oxide) | 4% |
| Cyclohexanone | 30% |
| Xylene mixture | 50% |

Emulsions of any required concentration can be obtained from this concentrate by dilution with water.

Various aspects and embodiments of the present invention will now be illustrated in more detail by way of example. It will be appreciated that modification of detail may be made with out departing from the scope of the invention.

For the avoidance of doubt, where a literary reference, patent application, or patent, is cited within the text of this application, the entire text of said citation is herein incorporated by reference.

### Biological Examples

Varroa mites came from bee colonies provided by a beekeeper. The mite population is kept in a dedicated apiary. For screening needs adults are collected on the same day as the beginning of experiment, either in beehive cells containing brood of worker bees or drones, or directly on bees emerging during collection.

Bee nymphs needed to feed adults of Varroa mites during experiments are choosen within the frames from which Varroa is also collected. They are collected at the stage of nymph with white or pink coloured eyes according methology described by Rembold et Kremer (Characterization of postembryonic developmental stages of the female castes of the honey bee, Apis mellifera L. Apidologie 11: 29-38).

3 cm diameter Petri dishes were used as confinement material of Varroa mites during experiments. Covers with wire mesh were put on the top of each Petri dish in order to avoid the mites to run away but also to keep favorable humidity for the bee nymph.

Applications were done with a Potter tower (described in “An improved apparatus for applying direct sprays and surface films with data on the electrostatic charge on atomize spray fluids.” Annal of Applied Biology, 39: 1-28.). Each active substance was apllied to achieve uniform distribution on the Petri dish (1.5 mg±0.2 mg/cm²). A check with distilled water was also tested. Treated Petri dishes were then placed under extractor hood during one our to dry the deposit.

After treatment of Petri dishes, five (5) adults of V. destructor collected from the brood were placed in the petri dish. Mites were left in direct contact with the spray deposit during 10 minutes, then a bee nymph was collected from brood and placed in each Petri dish. These Petri dishes were kept in hermetic boxes and left in an oven under suitable conditions (35±1.5° C. and hygrometry of 50±15%.). A check was always kept for each experiment. It is designed to correct the obtained mortality in treated petri dishes with natural mortality. During a test 20 Varroa adults are tested for a given compound (4 dishes of 5 individuals). Mortality levels are assessed after 72 h (mites which are able to move their legs are considered as alive). Table below illustrates the results from the experiments.

| | Concentration of | % mortality of |
|---|---|---|
| Active substance | formulation (SC240) | Varroa |
| spirodiclofen | 1.25 microlitre | 100 |
| spiromesifen | 0.8 microlitre | 100 |

1-4. (canceled)

5. A method of:
(i) controlling or protecting against bee mites;
(ii) reducing infestations of bee mites on bees or in or around their hives;
(iii) protecting bees from attack by mites; or
(iv) treatment of varroatosis,
which comprises bringing the mites in their various stages of development into contact with a composition comprising spirodiclofen and/or spiromesifen and an agrochemically acceptable diluent or carrier.

6. A method according to claim 5 wherein the mites are of the genus Varroa.

7. A method according to claim 6 wherein the mites are of the species Varroa destructor.

8. A method according to claim 5 which comprises the treatment of honey bees or in or around their hives.

9. A combination comprising (I) spirodiclofen and/or spiromesifen, and (II) one or more other agents suitable for use in treating bee mites, such as fluvalinate, tau-fluvalinmate, amitraz, formic acid, coumaphos, thymol and sucrose octanoate.

10. A composition comprising a combination according to claim 9, further comprising an agrochemically acceptable diluent or carrier.

11. A device or composition comprising spirodiclofen and/or spiromesifen which releases the spirodiclofen and/or spiromesifen respectively into a bee hive to be treated in a controlled manner so as to maintain an effective concentration of the active agent within the hive that is sufficient to kill mites that infest, or may infest, the hive.

12. A device or composition according to claim 11, which maintains an effective concentration of spirodiclofen and/or spiromesifen in the hive for up to 20 days below a level that may have a detrimental effect on the bees.
